(19) United States
(12) Patent Application Publication
(10) Pub. No.: US 2026/0216945 A1
(43) Pub. Date: Jul. 30, 2026

(54) SYSTEM FOR MAKING A PANEL WITH INTERNAL RIBBING AND ASSOCIATED METHODS

(71) Applicant: D & D Manufacturing LLC, Fletcher, NC (US)

(72) Inventors: Dale E. Polk, JR., Hendersonville, NC (US); Karl L. Polk, Hendersonville, NC (US)

(21) Appl. No.: 19/037,250

(22) Filed: Jan. 26, 2025

(51) Int. Cl. B29C 51/26; B29C 51/10; B29C 51/36; B29L 7/00

(52) U.S. Cl. CPC B29C 51/267; B29C 51/10; B29C 51/261; B29C 51/365; B29C 2791/006; B29L 2007/002

(57) ABSTRACT

A system for making a panel with internal ribbing includes a bottom mold having a bottom mold cavity that is to receive a first pliable thermoplastic sheet, and articulating rib forms movable between an extended position within the bottom mold cavity and a retracted position below the bottom mold cavity. A first vacuum pump pulls a vacuum on the bottom mold cavity while the articulating rib forms are in the extended position so that the first pliable thermoplastic sheet covers inner surfaces of the bottom mold cavity and the articulating rib forms. A top mold is to receive a second pliable thermoplastic sheet. A second vacuum pump pulls a vacuum on the top mold so that the second pliable thermoplastic sheet is held in place. The bottom and top molds are joined together so that the first and second pliable thermoplastic sheets are fused together to form the panel with internal ribbing.

### TECHNICAL FIELD

The present disclosure relates to thermoplastic panels, and, more particularly, to a system for making a thermoplastic panel with internal ribbing, and associated methods.

### BACKGROUND

Thermoplastic is a plastic polymer material that becomes pliable or moldable at elevated temperatures and solidifies upon cooling. Thermoplastic panels may be formed using compression molding or extrusion.

Compression molding is a manufacturing method for fabrication of composite materials. A preheated material is placed into an open heated mold cavity. The mold is closed and compressed under uniform pressure so that the polymer material contacts all areas of the mold. Then, the molding material is cured under determined temperature and pressure and removed from the system.

Extrusion is a process in which polymer material is melted and formed into a continuous profile. Objects with a specific cross-sectional shape may be made by forcing the polymer material through a die. The die may be a disk with an opening that is the desired shape and size. When pressure is applied to the polymer material as it passes through the die, it takes on the desired shape.

### SUMMARY

A system for making a panel with internal ribbing includes a bottom mold having a bottom mold cavity that is to receive a first pliable thermoplastic sheet, and articulating rib forms movable between an extended position within the bottom mold cavity and a retracted position below the bottom mold cavity. A first vacuum pump is configured to pull a vacuum on the bottom mold cavity while the articulating rib forms are in the extended position, with the vacuum causing the first pliable thermoplastic sheet to cover inner surfaces of the bottom mold cavity and the articulating rib forms.

A top mold is to receive a second pliable thermoplastic sheet while in an upright position. A second vacuum pump is configured to pull a vacuum on the top mold, with the vacuum causing the second pliable thermoplastic sheet to be held in place. A top mold control arm is configured to move the top mold from the upright position to an inverted position so that the second pliable thermoplastic sheet comes in contact with the first pliable thermoplastic sheet, with the first and second pliable thermoplastic sheets being fused together to form the panel with internal ribbing.

The system may include a rib forms controller configured to move the articulating rib forms from the extended position to the retracted position as the first and second pliable thermoplastic sheets are being fused together. This causes voids to be formed in the internal ribbing.

The first vacuum pump may continue to pull the vacuum on the bottom mold cavity causing the voids in the internal ribbing to be filled with the first pliable thermoplastic sheet as the articulating rib forms are moved to the retracted position.

After the top mold control arm moves the top mold back to the upright position, the rib forms controller may move the articulating rib forms back to the extended position to eject the panel with internal ribbing from the bottom mold cavity.

The top mold may include an L-shaped raised edge section that is to interface with a corresponding L-shaped recessed edge section in the bottom mold to define opposing interlocking edge sections of the panel. The vacuum from the second vacuum pump may further cause the second pliable thermoplastic sheet to cover the L-shaped raised edge section.

The first and second pliable thermoplastic sheets may be within a temperature range of 300-400° F. The vacuum for the first pump may be within a range of 5-10 psi, and the vacuum for the second pump may be within a range of 10-15 psi.

The bottom mold may include vacuum holes for the first vacuum pump, and the top mold may include vacuum holes for the second vacuum pump. The panel with the internal ribbing may be formed in-situ without using injection molding or extrusion compression.

Another aspect is directed to a method for making a panel with internal ribbing as described above. The method includes positioning a first pliable thermoplastic sheet over a bottom mold cavity in a bottom mold, with the bottom mold comprising articulating rib forms movable between an extended position within the bottom mold cavity and a retracted position below the bottom mold cavity. A first vacuum pump is operated to pull a vacuum on the bottom mold cavity while the articulating rib forms are in the extended position. The vacuum causes the first pliable thermoplastic sheet to cover inner surfaces of the bottom mold cavity and the articulating rib forms.

A second pliable thermoplastic sheet is positioned over a top mold cavity while the top mold is in an upright position. A second vacuum pump is operated to pull a vacuum on the top mold cavity. The vacuum causes the second pliable thermoplastic sheet to be held in place. The top mold is moved from the upright position to an inverted position so that the second pliable thermoplastic sheet comes in contact with the first pliable thermoplastic sheet. The first and second pliable thermoplastic sheets are fused together to form the panel with internal ribbing.

The articulating rib forms are moved from the extended position to the retracted position as the first and second pliable thermoplastic sheets are being fused together. This causes voids to be formed in the internal ribbing. The first vacuum pump continues to pull the vacuum on the bottom mold cavity causing the voids in the internal ribbing to be filled with the first pliable thermoplastic sheet as the articulating rib forms are moved to the retracted position.

### BRIEF DESCRIPTION OF THE DRAWINGS

FIG. 1 is a schematic diagram of a system for making a panel with internal ribbing in which various aspects of the disclosure may be implemented, wherein thermoplastic sheets are positioned over a bottom mold and over a top mold in an upright position.

FIG. 2 is a schematic diagram of the system illustrated in FIG. 1, wherein the top mold has been inverted to make contact with the bottom mold.

FIG. 3 is a schematic diagram of the system as illustrated in FIG. 2, wherein the top mold has been moved back to an upright position and the panel with internal ribbing has been extracted from the bottom mold.

FIG. 4 is a cross-sectional view of the extracted panel with internal ribbing as illustrated in FIG. 3.

FIG. 5 is a perspective view of the bottom and top molds for the system illustrated in FIG. 1.

FIG. 6 is a perspective view of thermoplastics sheets applied to the bottom and top molds illustrated in FIG. 5.

FIG. 7 is a cross-sectional perspective view of the thermoplastic sheets after being vacuumed to the bottom and top molds illustrated in FIG. 6.

FIG. 8 is a perspective view of the top mold being positioned on the bottom mold illustrated in FIG. 7.

FIG. 9 is a cross-sectional perspective view of the bottom and top molds after the top mold has been positioned on the bottom mold illustrated in FIG. 8, with the articulating rib forms in the extended position.

FIGS. 10-11 are cross-sectional perspective views of the bottom and top molds illustrated in FIG. 9, with voids being formed in the internal ribbing as the articulating rib forms are lowered to the retracted position.

FIG. 12 is a cross-sectional perspective view of the bottom and top molds illustrated in FIG. 11, with the voids being filled in by pulling a vacuum on the bottom mold.

FIG. 13 is a cross-sectional perspective view of the top mold being removed from the bottom mold illustrated in FIG. 12.

FIGS. 14-15 are cross-sectional perspective views of the bottom mold illustrated in FIG. 12, with the articulating rib forms being moved back to the extended position for ejecting the panel with the internal ribbing.

FIG. 16 is a cross-sectional perspective view of the bottom mold illustrated in FIG. 15, with extraction from the bottom mold of the panel with the internal ribbing.

FIG. 17 is a flowchart for making a panel with internal ribbing using the system illustrated in FIG. 1.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout.

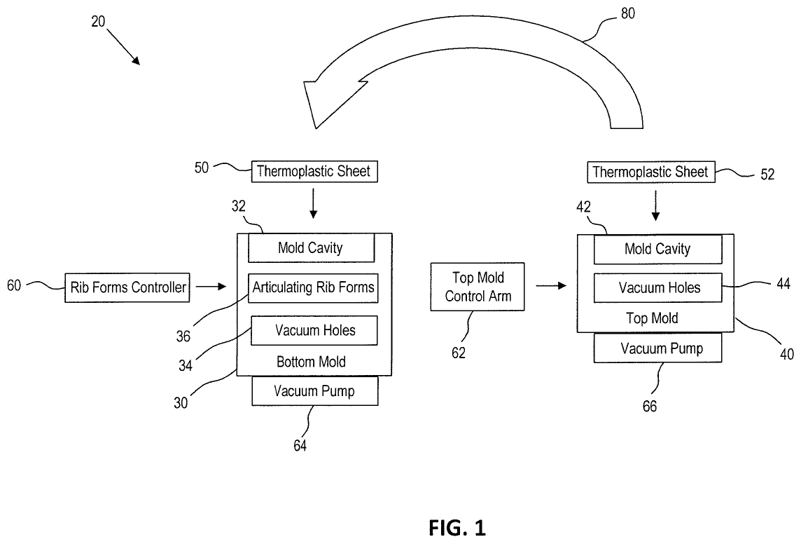

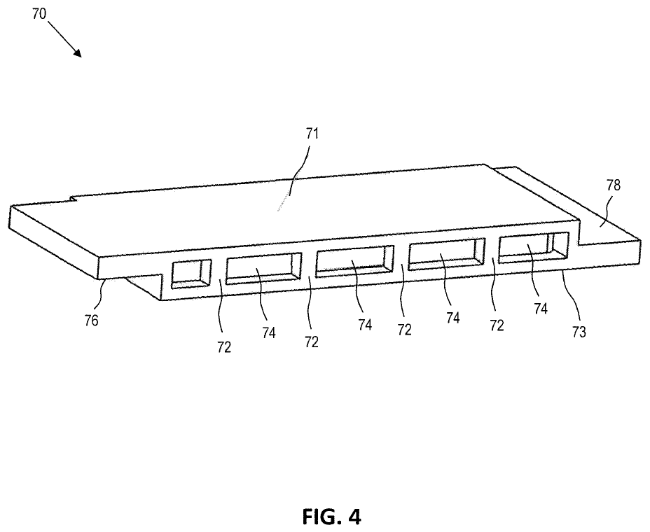

Referring initially to FIGS. 1-4, an overview of a system 20 for making a panel 70 with internal ribbing 72 will be discussed. The panel 70 with internal ribbing 72, as shown in FIG. 4, is advantageously formed in-situ without using injection molding or extrusion compression. The system 20 significantly lowers the operating and capital costs of making such a panel 70. The panel 70 may be joined with other panels to form a wall or other structure required to support heavy loads.

The system 20 includes a bottom mold 30 that includes a mold cavity 32 formed therein, articulating rib forms 36, and vacuum holes 34. A rib forms controller 60 is coupled to the articulating rib forms 36 for controlling movement thereof between an extended position and a retracted position. In the extended position, the articulating rib forms 36 are positioned within the bottom mold cavity 32. In the retracted position, the articulating rib forms 36 are positioned below the bottom mold cavity 32.

A first thermoplastic sheet 50 is placed over the bottom mold cavity 32 while the articulating rib forms 36 are in the extended position. The first thermoplastic sheet 50 is at an elevated temperature so that the sheet is soft and pliable. The elevated temperature may be within the range of 300-400° F., for example.

While the first thermoplastic sheet 50 is resting on the mold cavity 32, a first vacuum pump 64 is used to pull a vacuum on the mold cavity 32 via the vacuum holes 34. The vacuum may be within a range of 5-10 psi, for example. The vacuum holes 34 are spread out across a lower surface of the bottom mold 30 and interface with the bottom mold cavity 32. As the vacuum is applied to the bottom mold 30, the first thermoplastic sheet 50 is pulled down to cover the articulating rib forms 36 and the interior surfaces of the bottom mold cavity 32. The interior surfaces of the bottom mold cavity 32 includes side walls and bottom surfaces thereof.

The system 20 further includes a top mold 40 that includes a raised edge section 42 that is to interface with a corresponding recessed edge section in the bottom mold 30 to define opposing interlocking edge sections 76, 78 of the panel 70. The raised edge section 42 and the corresponding recessed edge section may be a L-shaped, for example. Vacuum holes 44 are spread out across an upper surface of the top mold 40.

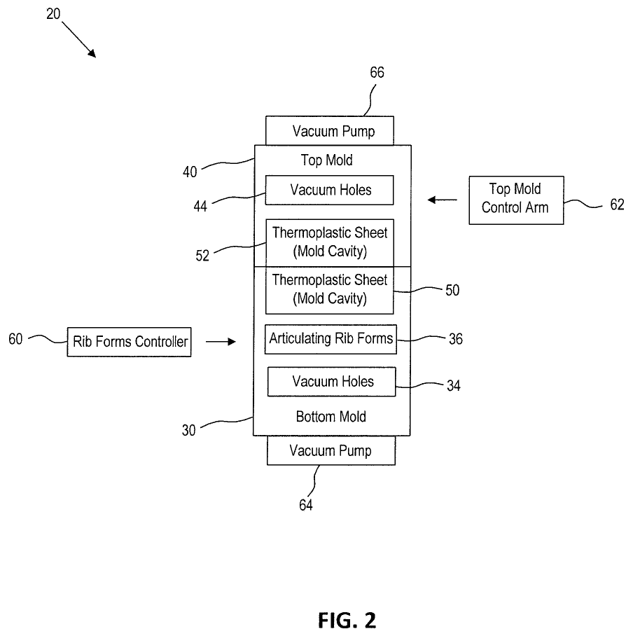

A top mold control arm 62 is coupled to the top mold 40 for controlling movement thereof between an upright position as shown in FIG. 1, and an inverted position as shown in FIG. 2. A second thermoplastic sheet 52 is placed over the top mold 40 and the L-shaped raised edge section 42 while in the upright position. The second thermoplastic sheet 52 is also at the elevated temperature so that the sheet is soft and pliable.

While the second thermoplastic sheet 52 is resting on the top mold 40 and the L-shaped raised edge section 42, a second vacuum pump 66 is used to pull a vacuum on the top mold 40 via the vacuum holes 44. The vacuum may be within a range of 10-15 psi, for example.

As the vacuum is applied to the top mold 40, the second thermoplastic sheet 52 is pulled down to cover the L-shaped raised edge section 42 and to cover the upper surface of the top mold 40. The vacuum for the top mold 40 may be higher than the vacuum for the first mold 30 to ensure that the second thermoplastic sheet 52 is held in place as the top mold 40 is moved from the upright position to the inverted position.

The top mold control arm 62 then moves the top mold 40 from the upright position to an inverted position, as indicated by arrow 80 in FIG. 1. As the top mold 40 is inverted, the second vacuum pump 66 continues to pull a vacuum so that the second thermoplastic sheet 42 is held in place by the top mold 40.

The top mold 40 is inverted so that the second thermoplastic sheet 52 carried by the top mold 40 comes in contact with the thermoplastic sheet 50 in the bottom mold 30, as shown in FIG. 2. The top mold 40 is aligned with the bottom mold 50. As the first and second thermoplastic sheets 50, 52 come in contact with one another at the elevated temperature, they become fused together to form the panel 70 with internal ribbing 72.

After the first and second thermoplastic sheets 50, 52 have been fused together, the rib forms controller 60 moves the articulating rib forms 36 from the extended position back to the retracted position. In the retracted position, the articulating rib forms 36 are positioned below the bottom mold cavity 32.

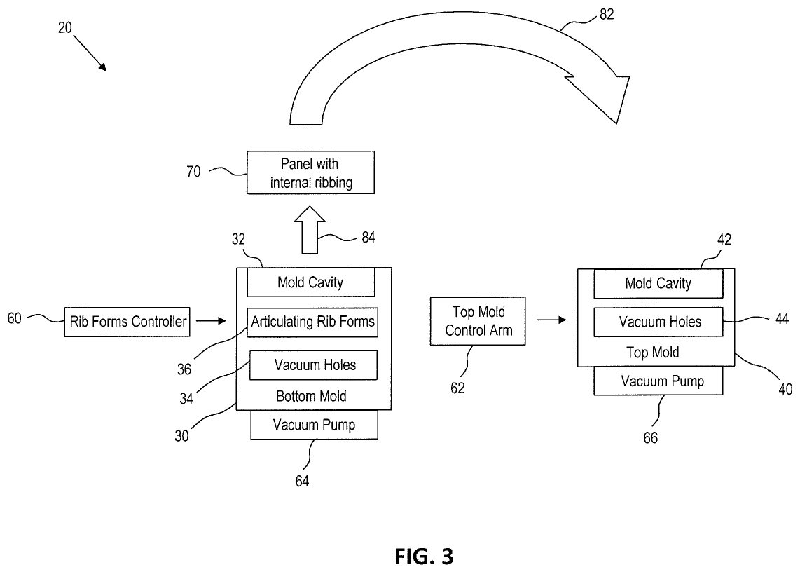

Retraction of the articulating rib forms 36 from the internal ribbing 72 in the bottom mold cavity 32 causes voids to be formed in the internal ribbing. To fill in the voids, the first vacuum pump 64 continues to pull a vacuum on the bottom mold cavity 32. This causes the first thermoplastic sheet 50 at the elevated temperature to fill in the voids. After the voids have been filled, the second vacuum pump 66 for the top mold 50 stops pulling a vacuum, and the top mold control arm 62 moves the top mold 40 back to the upright position, as indicated by arrow 82 and as shown in FIG. 3.

The panel 70 with the internal ribbing 72 is ready for extraction from the bottom mold cavity 32. This is accomplished by operating the rib forms controller 60 to move the articulating rib forms 36 back to the extended position. As the articulating rib forms 36 move back to the extended position, the panel 70 is pushed out of the bottom mold cavity 32 by the articulating rib forms 36, as indicated by arrow 84.

A cross-sectional view of the panel 70 is provided in FIG. 4. The panel 70 includes an upper surface 71 and a bottom surface 73, with the ribs 72 therebetween. Adjacent the ribs 72 are pockets 74 void of any thermoplastic material. The panel 70 includes an upper interlocking edge section 76 extending from one side of the panel 70, and a lower interlocking edge section 78 extending from an opposite side of the panel 70. The upper and lower interlocking edge sections 78 are used to join adjacent panels 70 together to form a wall or structure. Fasteners may be used to hold the panels together.

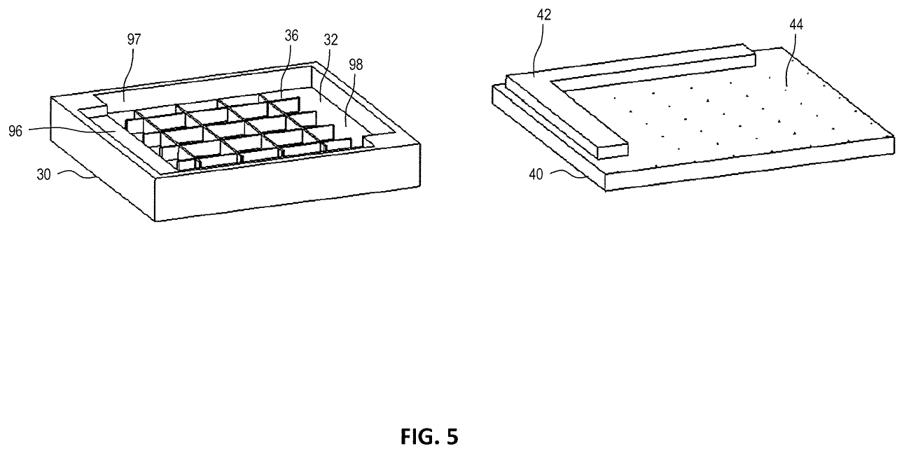

Referring now to FIGS. 5-16, the steps of forming the panel 70 with internal ribbing 72 will be discussed in greater detail. The articulating rib forms 36 are in the extended position within the bottom mold cavity 32 in the bottom mold 30, as shown in FIG. 5.

The bottom mold cavity 32 includes an upper extension area 96 for the upper interlocking edge section 76 of the panel that is to extend from one side of the panel 70, and a lower extension area 98 for the lower interlocking edge section 78 extending from an opposite side of the panel 70. The articulating rib forms 36 do not extend into the upper and lower extension areas 96, 98.

The top mold 40 includes an L-shaped raised section 42 that is to interface with a corresponding L-shaped recessed edge section 97 in the bottom mold 30 to define the interlocking edge sections 76, 78 of the panel 70. Vacuum holes 44 extend through the top mold 40 in order for the second vacuum pump 66 to pull a vacuum on the second thermoplastic sheet 52.

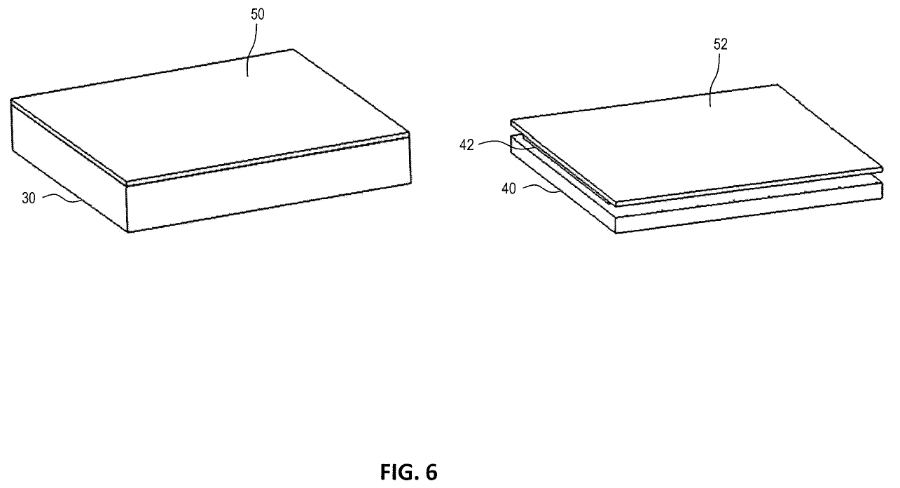

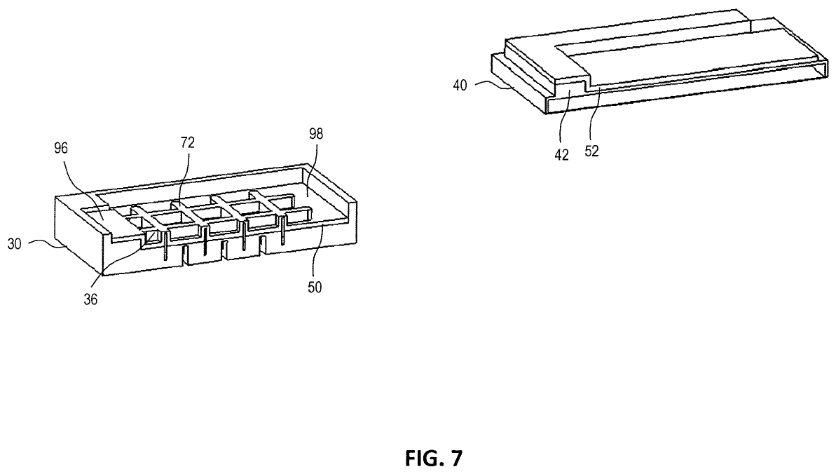

A first thermoplastic sheet 50 is positioned over the bottom mold 30, and a second thermoplastic sheet 52 is positioned over the top mold 40, as shown in FIG. 6. The first and second thermoplastic sheets 50, 52 are at elevated temperatures so that the sheets are soft and pliable. A cross-sectional view of the bottom mold 30 and the top mold 40 are shown in FIG. 7 after the first and second thermoplastic sheets 50, 52 have been vacuumed down to their respective molds.

As the vacuum is applied to the bottom mold 30, the first thermoplastic sheet 50 is pulled down to cover the articulating rib forms 36 to form the internal ribbing 72, and to cover the interior surfaces of the bottom mold cavity 32. The interior surfaces of the bottom mold cavity 32 includes side walls and bottom surfaces thereof.

As the vacuum is applied to the top mold 40, the second thermoplastic sheet 52 is pulled down to cover the L-shaped raised section 42 and the upper surface of the top mold 40.

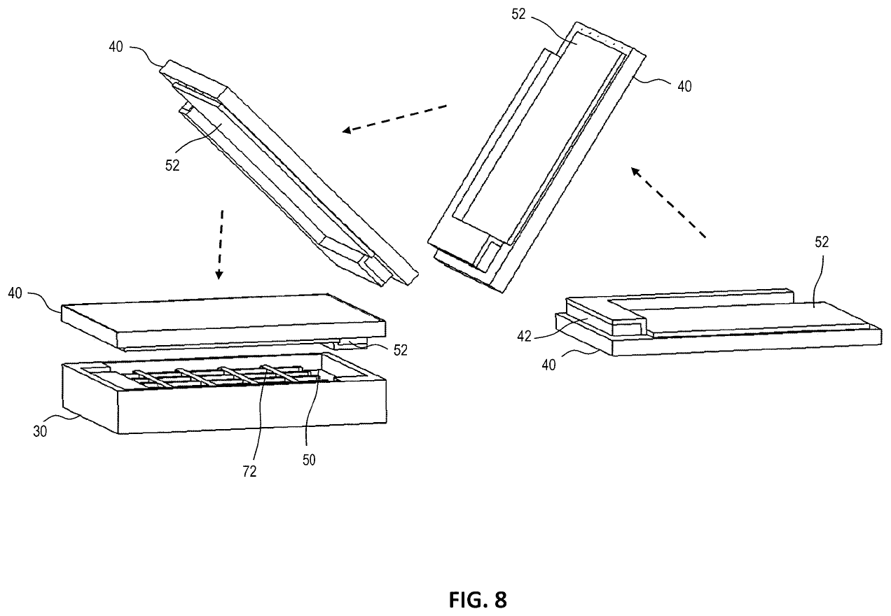

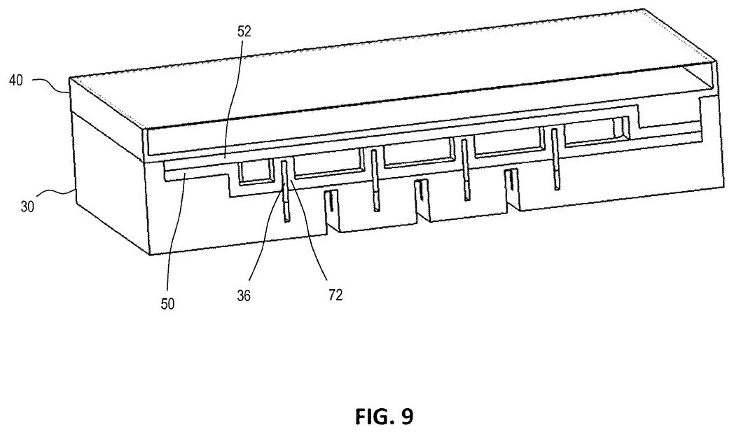

The top mold 40 is moved from an upright position to an inverted position, as indicated by the dashed arrows in FIG. 8, while the second thermoplastic sheet 52 is being held in place by the second vacuum pump 66. The top mold 40 is inverted so that the second thermoplastic sheet 52 carried by the top mold 40 comes in contact with the first thermoplastic sheet 50 in the bottom mold 30, as shown in FIG. 9.

The top mold 40 is aligned with the bottom mold 50. As the first and second thermoplastic sheets 50, 52 come in contact with one another at the elevated temperature, they become fused or welded together to form the panel 70 with internal ribbing 72. In particular, an upper surface of the internal ribbing 72 formed with the first thermoplastic sheet 50 is welded to a bottom surface of the second thermoplastic sheet 52 while the articulating rib forms 36 are in the extended position.

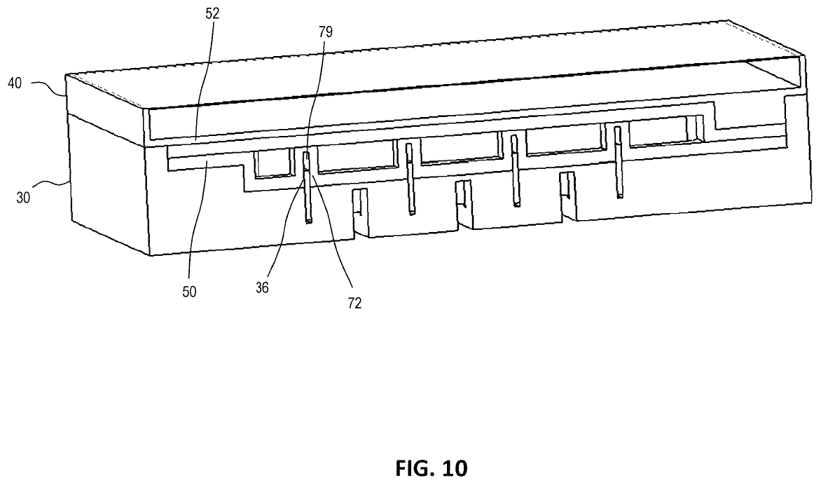

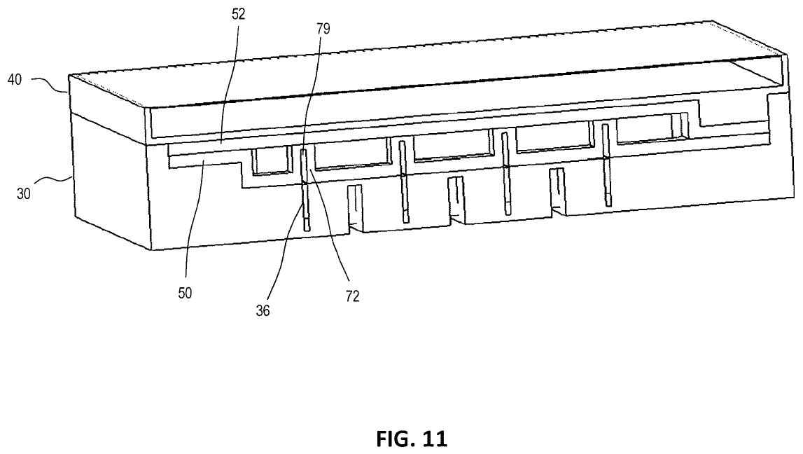

The articulating rib forms 36 are then moved from the extended position to the retracted position as the first and second pliable thermoplastic sheets 50, 52 are being fused together, as shown in FIGS. 10-11. Retraction of the articulating rib forms 36 causes voids 79 to be formed in the internal ribbing 72.

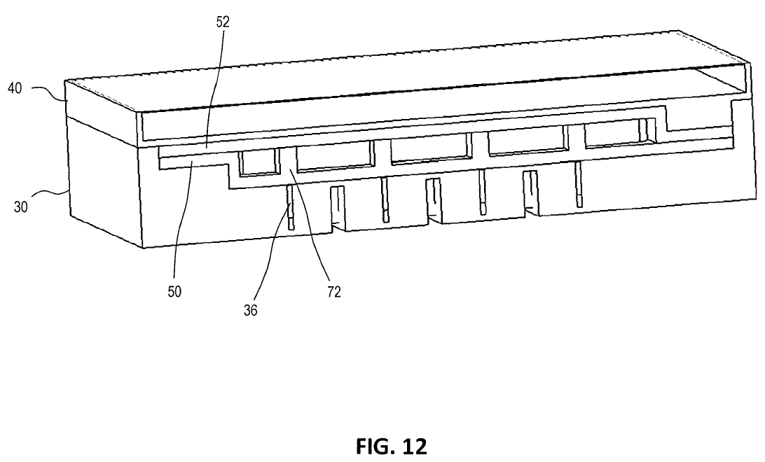

The articulating rib forms 36 are in a partially retracted position in FIG. 10, and are in a fully retracted position in FIG. 11. The voids 79 increase in size as the articulating rib forms 36 are retracted. The first vacuum pump 64 continues to pull the vacuum on the bottom mold cavity 32 as the articulating rib forms 36 are being retracted. This causes the voids 79 in the internal ribbing 72 to be filled with the first thermoplastic sheet 50, as shown in FIG. 12.

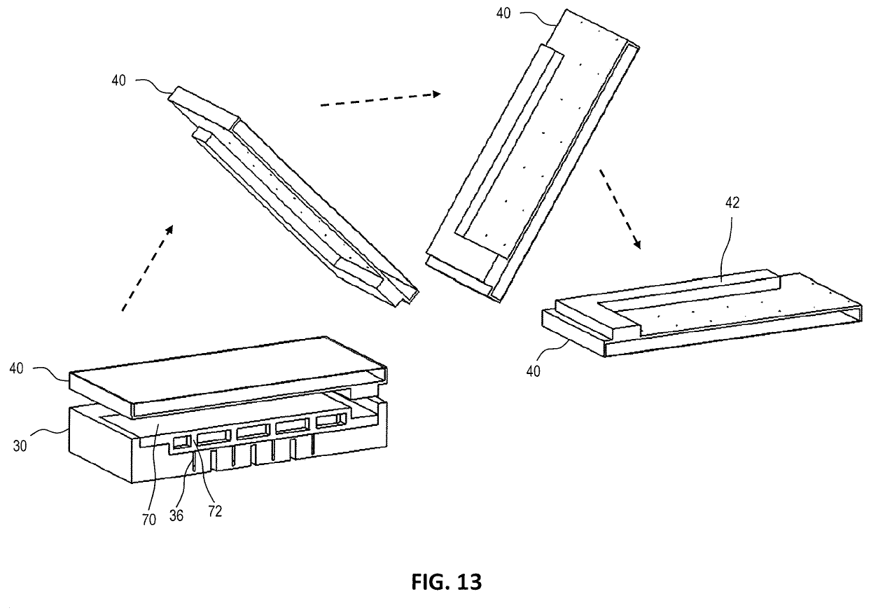

After the panel 70 with the internal ribbing 72 has been formed, the top mold 40 is moved from the inverted position back to the upright position, as shown in FIG. 13. The top mold 40 is in position to receive another second thermoplastic sheet 52 for the next panel 70 with internal ribbing 72 to be formed.

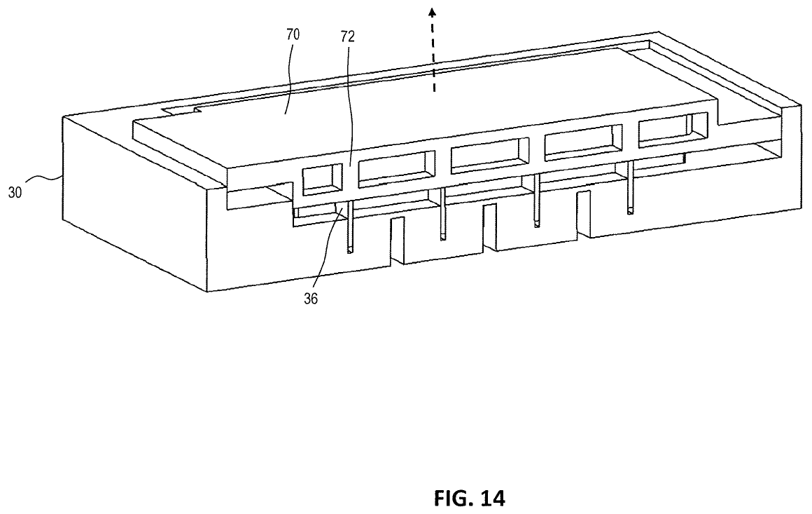

With the top mold 40 in the upright position, this allows the panel 70 with the internal ribbing 72 to be extracted from the bottom mold cavity 32, as shown in FIG. 14. This is based on the articulating rib forms 36 being moved back to the extended position.

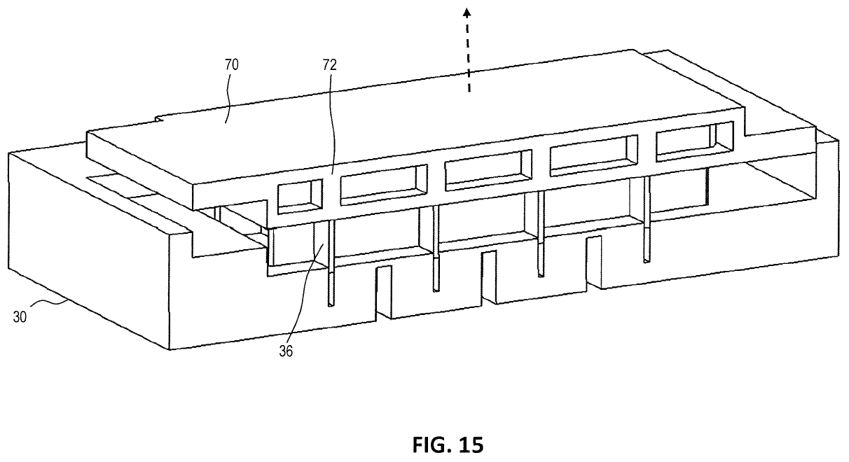

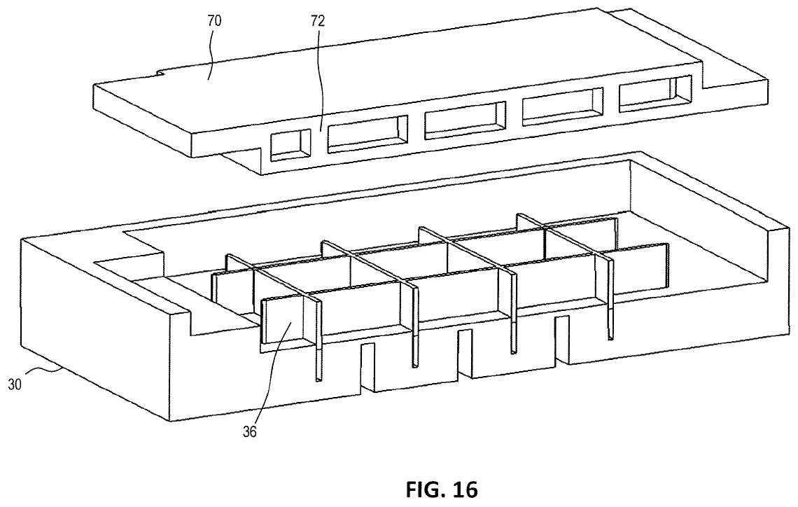

As the articulating rib forms 36 are moved, the panel 70 with the internal ribbing 72 is pushed out of the bottom mold cavity 32. With the articulating rib forms 36 in the fully extended position, the panel 70 with the internal ribbing 72 is ready for extraction, as shown in FIG. 15. The panel 70 with the internal ribbing 72 has been extracted, as shown in FIG. 16. The bottom mold 30 is ready to receive another first thermoplastic sheet 50 for the next panel 70 with internal ribbing 72 to be formed.

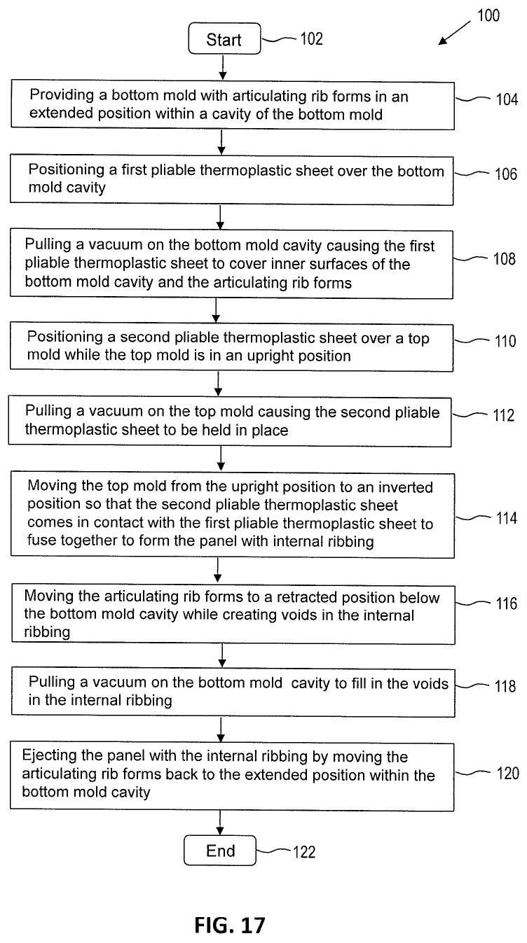

Another aspect is directed to a method for making a panel 70 with internal ribbing 72 using the system 20 as discussed above. Referring now to the flowchart 100 in FIG. 17, from the start (Block 102), the method includes providing a bottom mold 30 with articulating rib forms 36 in an extended position within a cavity 32 of bottom mold at Block 104. A first pliable thermoplastic sheet 50 is positioned over the bottom mold cavity 32 at Block 106. A vacuum is pulled on the bottom mold cavity 32 at Block 108 causing the first pliable thermoplastic sheet 50 to cover inner surfaces of the bottom mold cavity 32 and the articulating rib forms 36.

A second pliable thermoplastic sheet 52 is positioned over a top mold 40 at Block 110 while the top mold is in an upright position. A vacuum is pulled on the top mold 40 at Block 112 causing the second pliable thermoplastic sheet 52 to be held in place. The top mold 40 is moved from the upright position to an inverted position at Block 114 so that the second pliable thermoplastic sheet 52 comes in contact with the first pliable thermoplastic sheet 50 to fuse together to form the panel 70 with internal ribbing 72.

The articulating rib forms 36 are moved at Block 116 to a retracted position below the bottom mold cavity 32 while creating voids 79 in the internal ribbing 72. A vacuum is pulled on the bottom mold cavity 32 at Block 118 to fill in the voids 79 in the internal ribbing 72. The panel 70 with the internal ribbing 72 is ejected from the bottom mold 30 at Block 120 by moving the articulating rib forms 36 back to the extended position within the bottom mold cavity 32. The method ends at Block 122.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A system for making a panel with internal ribbing comprising:
a bottom mold having a bottom mold cavity that is to receive a first pliable thermoplastic sheet, and articulating rib forms movable between an extended position within the bottom mold cavity and a retracted position below the bottom mold cavity;
a first vacuum pump configured to pull a vacuum on the bottom mold cavity while the articulating rib forms are in the extended position, with the vacuum causing the first pliable thermoplastic sheet to cover inner surfaces of the bottom mold cavity and the articulating rib forms;
a top mold to receive a second pliable thermoplastic sheet while in an upright position;
a second vacuum pump configured to pull a vacuum on the top mold, with the vacuum causing the second pliable thermoplastic sheet to be held in place; and
a top mold control arm configured to move the top mold from the upright position to an inverted position so that the second pliable thermoplastic sheet comes in contact with the first pliable thermoplastic sheet, with the first and second pliable thermoplastic sheets being fused together to form the panel with internal ribbing.

2. The system according to claim 1 comprising a rib forms controller configured to move the articulating rib forms from the extended position to the retracted position as the first and second pliable thermoplastic sheets are being fused together, and causing voids to be formed in the internal ribbing.

3. The system according to claim 2 wherein the first vacuum pump continues to pull the vacuum on the bottom mold cavity causing the voids in the internal ribbing to be filled with the first pliable thermoplastic sheet as the articulating rib forms are moved to the retracted position.

4. The system according to claim 3 wherein after the top mold control arm moves the top mold back to the upright position, the rib forms controller is configured to move the articulating rib forms back to the extended position to eject the panel with internal ribbing from the bottom mold cavity.

5. The system according to claim 1 wherein the top mold comprises an L-shaped raised edge section that is to interface with a corresponding L-shaped recessed edge section in the bottom mold to define opposing interlocking edge sections of the panel, with the vacuum from the second vacuum pump further causing the second pliable thermoplastic sheet to cover the L-shaped raised edge section.

6. The system according to claim 1 wherein the first and second pliable thermoplastic sheets are within a temperature range of 300-400° F.

7. The system according to claim 1 wherein the vacuum for the first pump is within a range of 5-10 psi, and the vacuum for the second pump is within a range of 10-15 psi.

8. The system according to claim 1 wherein the bottom mold includes vacuum holes for the first vacuum pump, and the top mold includes vacuum holes for the second vacuum pump.

9. The system according to claim 1 wherein the panel with the internal ribbing is formed in-situ without using injection molding or extrusion compression.

10. A method for making a panel with internal ribbing comprising:
positioning a first pliable thermoplastic sheet over a bottom mold cavity in a bottom mold, with the bottom mold comprising articulating rib forms movable between an extended position within the bottom mold cavity and a retracted position below the bottom mold cavity;
operating a first vacuum pump to pull a vacuum on the bottom mold cavity while the articulating rib forms are in the extended position, with the vacuum causing the first pliable thermoplastic sheet to cover inner surfaces of the bottom mold cavity and the articulating rib forms;
positioning a second pliable thermoplastic sheet over a top mold cavity while the top mold is in an upright position;
operating a second vacuum pump to pull a vacuum on the top mold cavity, with the vacuum causing the second pliable thermoplastic sheet to be held in place; and
moving the top mold from the upright position to an inverted position so that the second pliable thermoplastic sheet comes in contact with the first pliable thermoplastic sheet, with the first and second pliable thermoplastic sheets being fused together to form the panel with internal ribbing.

11. The method according to claim 10 comprising moving the articulating rib forms from the extended position to the retracted position as the first and second pliable thermoplastic sheets are being fused together, and causing voids to be formed in the internal ribbing.

12. The method according to claim 11 wherein the first vacuum pump continues to pull the vacuum on the bottom mold cavity causing the voids in the internal ribbing to be filled with the first pliable thermoplastic sheet as the articulating rib forms are moved to the retracted position.

13. The method according to claim 12 wherein after moving the top mold back to the upright position, the articulating rib forms are moved back to the extended position to eject the panel with internal ribbing from the bottom mold cavity.

14. The method according to claim 10 wherein the top mold comprises an L-shaped raised edge section that is to interface with a corresponding L-shaped recessed edge section in the bottom mold to define opposing interlocking edges of the panel, with the vacuum from the second vacuum pump further causing the second pliable thermoplastic sheet to cover the L-shaped raised edge section.

15. The method according to claim 10 wherein the first and second pliable thermoplastic sheets are within a temperature range of 300-400° F.

16. The system according to claim 10 wherein the vacuum for the first pump is within a range of 5-10 psi, and the vacuum for the second pump is within a range of 10-15 psi.

17. The method according to claim 10 wherein the bottom mold includes vacuum holes for the first vacuum pump, and the top mold includes vacuum holes for the second vacuum pump.

18. The method according to claim 10 wherein the panel with the internal ribbing is formed in-situ without using injection molding or extrusion compression.

19. A system for making a panel with internal ribbing comprising:
a bottom mold having a bottom mold cavity that is to receive a first pliable thermoplastic sheet, and articulating rib forms movable between an extended position and a retracted position;
a first vacuum pump configured to pull a vacuum on the bottom mold cavity while the articulating rib forms are in the extended position, with the vacuum causing the first pliable thermoplastic sheet to cover inner surfaces of the bottom mold cavity and the articulating rib forms;
a top mold to receive a second pliable thermoplastic sheet;
a second vacuum pump configured to pull a vacuum on the top mold, with the vacuum causing the second pliable thermoplastic sheet to be held in place while the bottom and top molds come in contact with one another so that the first and second pliable thermoplastic sheets are fused together to form the panel with internal ribbing.

20. The system according to claim 19 comprising a rib forms controller configured to move the articulating rib forms from the extended position to the retracted position as the first and second pliable thermoplastic sheets are being fused together, and causing voids to be formed in the internal ribbing, with the first vacuum pump continuing to pull the vacuum on the bottom mold cavity causing the voids in the internal ribbing to be filled with the first pliable thermoplastic sheet as the articulating rib forms are moved to the retracted position.
